(19) United States
(12) Patent Application Publication
(10) Pub. No.: US 2022/0315685 A1
(43) Pub. Date: Oct. 6, 2022

(54) MOISTURE CURABLE POLYACRYLATE COMPOSITIONS AND USES THEREOF

(71) Applicant: Henkel AG & Co., KGaA, Dusseldorf (DE)

(72) Inventors: Yuxia Liu, Dayton, NJ (US); Geetanjaliben A. Shah, Somerset, NJ (US); Abhijit Hirekerur, Troy, MI (US); Alfred A. Decato, Highland, MI (US)

(21) Appl. No.: 17/807,189

(22) Filed: Jun. 16, 2022

Related U.S. Application Data
(63) Continuation of application No. PCT/US2020/065324, filed on Dec. 16, 2020.
(60) Provisional application No. 62/950,614, filed on Dec. 19, 2019.

(51) Int. Cl. C08F 220/18; C08F 230/08

(52) U.S. Cl. CPC C08F 220/1804; C08F 220/1802; C08F 230/085

(57) ABSTRACT

Moisture curable polyacrylate polymers with pedant moisture reactive silyl-functional groups bound to the polymer chain and compositions comprising the same polyacrylate polymers are provided. The polyacrylate polymers and the compositions cure by way of a condensation mechanism in the presence of moisture and a catalyst. The moisture curable polyacrylate polymers and compositions provide excellent resistance to automotive oil at high temperature and are particularly useful as sealants and gaskets in automotive powertrains.

### FIELD OF THE INVENTION

The invention relates to moisture curable polyacrylates and compositions thereof. The moisture curable polyacrylates and compositions provide show good petroleum oil and heat resistance, and are particularly suitable as room-temperature-vulcanizing sealants and adhesives for automotive gasketing.

### BACKGROUND OF THE INVENTION

Curable polyacrylates and compositions are used as adhesives, sealants, coatings, paintings, encapsulants, and the like, in a broad range of applications including packaging, automotive, construction, highway, electronic device, appliance assembly and consumer uses. Polyacrylate polymers are an important class of polymers that are soft, tough and rubbery. Their glass transition temperature is well below room temperature. They are known for their high transparency, good impact toughness and elasticity, and have fairly good heat resistance up to 450 K under dry heat. They also have good weatherability and ozone resistance since they do not have double bonds in the backbone.

Typically, curable polyacrylate compositions and compositions used in these applications have been tailored to provide strength, toughness, cure speed, modulus, elongation; and resistance to high temperatures, petroleum oils and humidity. For instance, the curable polyacrylates and compositions can form into gaskets, which are used extensively in the automotive industry. In use, polyacrylate compositions are subjected to a variety of conditions, and must continue to function without compromised integrity. One such condition includes exposure to engine oil at elevated temperatures. Polyacrylate polymers of ethyl and acrylates, which exhibit excellent resistance to petroleum fuels and oils, can retain their properties when sealing petroleum oils at high temperatures of up to 300° F. These properties make polyacrylates suitable for use in automotive automatic transmissions, steering systems, and other applications where petroleum and high temperature resistance are required. Polyacrylates are not recommended for applications where the elastomer will be exposed to brake fluids, chlorinated hydrocarbons, alcohol, or glycols.

Oil resistant materials are described in U.S. Pat. Nos. 3,326,868, 2,492,170, 3,315,012, and 3,445,403 where heat-curable acrylate rubbers are prepared by polymerizing in aqueous emulsion (a) 50 to 99.8% by weight of b-methoxy- or b-ethoxyethyl acrylate; (b) 0 to 40% by weight of one or more rubber-producing alkyl or cyanoalkyl esters of acrylic or methacrylic acid, whose homopolymers have second order transition temperatures below 10° C.; (c) 0 to 20% by weight of acrylonitrile; (d) 0.2 to 2.5% by weight of an N-alkoxy methyl-acrylamide or -methacrylamide wherein the alkoxy radical contains 1 to 8 carbon atoms; and (e) 0 to 3.8% by weight of a monoolefinically and terminally unsaturated amide containing at least one hydrogen on the amide nitrogen and wherein the olefinic unsaturation is alpha-beta to the carbonyl group of the amide and the remainder of the molecule consists only of hydrogen atoms or carbon and hydrogen atoms, the total of constituents (d) and (e) not exceeding 4% by weight. U.S. Pat. Nos. 3,875,092, 3,910,866, and 4,405,758 also disclose heat or dual curable acrylate rubbers having both carboxyl and active halogen groups are compounded with a combination of sodium stearate and a tetramethyl thiuram disulfide or a Group IB, IIB, IVA, VA, and VIA metal compound thereof to provide compounded acrylate rubbers having an excellent scorch/cure rate balance and desirable physical properties in the vulcanizates thereof. But the above techniques do not teach moisture curable composition.

U.S. Pat. Nos. 7,129,294, 6,274,688, 6,420,492, 6,441,101, 6,667,369, 4,334,036, 7,439,308, 7,276,574 and 5,986,014 disclose oil resistance (meth)acrylic polymers having alkenyl or curable silyl groups at the chain ends in high functionality ratios are prepared by a process which comprises (i) preparing a (meth)acrylic polymer having halogen atoms at the chain ends, using an organohalogenated compound or a halosulfonyl compound as an initiator and a metal complex catalyst wherein the central metal atom is selected from the group consisting of the elements of Groups 8, 9, 10 and 11 of the periodic table; and (ii) transforming the halogen atom into an alkenyl group- or a curable silyl group-containing substituent. The obtained (meth)acrylic polymers form homogeneous curing materials. Methods for producing these (meth)acrylic polymer having crosslinkable silyl groups at the termini, comprising a step of adding a hydrosilane compound having a crosslinkable silyl group to an alkenyl-terminated (meth)acrylic polymer (A), which is prepared by atom transfer radical polymerization, in the presence of a platinum hydrosilylation catalyst. The amount of the platinum hydrosilylation catalyst is 0.1 to 10 mg on a platinum metal basis per kilogram of the alkenyl-terminated (meth)acrylic polymer (A). An object of the invention is to provide a method for producing a (meth)acrylic polymer having terminal crosslinkable silyl. These moisture curable alkoxysilane terminated polyacrylate are commercially available from Kaneka Corporation, Japan, which are currently prepared in a two-step process. In the disclosed processes, bromine substitution with an unsaturated carboxylic acid is followed by hydrosilation with an alkoxysilane. This two-step process can be expensive and time consuming for the manufacturer.

Therefore, it would be desirable to identify simple and alternative synthetic schemes to make moisture curable polyacrylates and compositions, including raw material reactant availability and reducing the complexity of the polymer structures and their synthesis. The current invention fulfills this need.

### BRIEF SUMMARY OF THE INVENTION

The invention provides moisture curable polyacrylates formed by random polymerization and compositions thereof. The compositions maintain mechanical properties after prolonged exposure to high temperature in petroleum oils; and are particularly suitable as sealants and adhering flanges in automotive powertrains.

One aspect of the invention is directed to a polyacrylate polymer with pedant alkoxy or other moisture reactive silyl-functional groups bound to the polymer chain.

The polyacrylate polymer is prepared with:
i. 20 to 70% by weight of a first acrylic or methacrylic acid derivative having a structure of CH₂═CR¹COOR², where R¹ is H or CH₃ and R² is a C4-24 linear, branched or cyclic alkyl chain, or combination thereof,
ii. 20 to 70% by weight of a second acrylic or methacrylic acid derivative having a structure of CH₂═CR¹COXR³, where R¹ is H or CH₃; X is O, NR³, S; R³ is H, C1-2 alkyl chain or a combination thereof, and
iii. 0.1 to 10% by weight of a silane functional acrylic or methacrylic acid derivative having a structure of CH₂═CR¹COOR⁴SiR⁵₄₋ₙYₙ, where R¹ is H or CH₃; R⁴ is a C1-24 linear, branched or cyclic alkylene or arylene chain; R⁵ is a C1-24 linear, branched or cyclic alkyl chain; Y is C1-3 alkoxy, aryloxy, acetoxy, oximino, enoxy, amino, ester, amide, lactate ester, lactate amide, H, OH, halogen, or combination thereof; n=1, 2, or 3.

Yet another aspect of the invention is directed to a method of forming the moisture curable polyacrylate polymer comprising:

1) polymerizing with a reaction temperature of about 50 to about 120° C. for about 4 to 24 hours of:
a. 40 to 90% by weight of a mixture of:
   i. 20 to 70% by weight of a first acrylic or methacrylic acid derivative having a structure of CH₂═CR¹COOR², where R¹ is H or CH₃ and R² is a C4-24 linear, branched or cyclic alkyl chain, or combination thereof,
   ii. 20 to 70% by weight of a second acrylic or methacrylic acid derivative having a structure of CH₂═CR¹COXR³, where R¹ is H or CH₃; X is O, NR³, S; R³ is H, C1-2 alkyl chain or a combination thereof, and
   iii. 0.1 to 10% by weight of a silane functional acrylic or methacrylic acid derivative having a structure of CH₂═CR¹COOR⁴SiR⁵₄₋ₙYₙ, where R¹ is H or CH₃; R⁴ is a C1-24 linear, branched or cyclic alkylene or arylene chain; R⁵ is a C1-24 linear, branched or cyclic alkyl chain; Y is C1-3 alkoxy, aryloxy, acetoxy, oximino, enoxy, amino, ester, amide, lactate ester, lactate amide, H, OH, halogen, or combination thereof; n=1, 2, or 3,
b. 10-60% by weight of an alcohol of the formula HOR⁶, where R⁶ is C₁₋₄ linear or branched alkyl chain,
c. 0-60% by weight of an ester of the formula R⁷COOR⁸, where R⁷ and R⁸ is independently C₁₋₄ alkyl chain,
d. 0.01 to 5% of an azo or peroxide radical initiator,

2) removing the solvents and any volatile at the temperature from about 50 to about 120° C. under a vacuum from about 10 to 30 psi

wherein the resultant polyacrylate polymer has a weight average molecular weight (Mw) of about 1,000 g/mol to about 100,000g/mol and a PDI from about 1.5 to 10.

Another aspect of the invention is directed to a moisture curable composition comprising:

1) about 10 to 90% by weight of a moisture curable polyacrylate polymer prepared from:
i. 20 to 70% by weight of a first acrylic or methacrylic acid derivative having a structure of CH₂═CR¹COOR², where R¹ is H or CH₃ and R² is a C4-24 linear, branched or cyclic alkyl chain, or combination thereof,
ii. 20 to 70% by weight of a second acrylic or methacrylic acid derivative having a structure of CH₂═CR¹COXR³, where R¹ is H or CH₃; X is O, NR³, S; R³ is H, C1-2 alkyl chain or a combination thereof, and
iii. 0.1 to 10% by weight of a silane functional acrylic or methacrylic acid derivative having a structure of CH₂═CR¹COOR⁴SiR⁵₄₋ₙYₙ, where R¹ is H or CH₃; R⁴ is a C1-24 linear, branched or cyclic alkylene or arylene chain; R⁵ is a C1-24 linear, branched or cyclic alkyl chain; Y is C1-3 alkoxy, aryloxy, acetoxy, oximino, enoxy, amino, ester, amide, lactate ester, lactate amide, H, OH, halogen, or combination thereof; n=1, 2, or 3;

2) about 5 to about 90% of a finely divided inorganic filler or a mixer of fillers;

3) about 0.001 to about 0.5% by weight of a moisture or acid scavenger, or combination thereof;

4) about 0.001 to about 5% by weight of a moisture curing catalyst; and

5) optionally, up to about 10% by weight of a crosslinker, adhesion promotor, plasticizer, acid scavenger, pigment, inhibitor, and/or odor mask.

### BRIEF DESCRIPTION OF THE DRAWINGS

FIG. 1 is the viscosity of the polymers by frequency sweep.

FIG. 2 is dynamic mechanical analysis (DMA) of the polymers.

### DETAILED DESCRIPTION OF THE INVENTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

As used in the specification and in the claims, the term “comprising” may include the embodiments “consisting of and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of and “consisting essentially of the enumerated ingredients/steps, which allows the presence of only the named ingredients/steps, along with any impurities that might result therefrom, and excludes other ingredients/steps.

Numerical values in the specification and claims of this application, particularly as they relate to polymers or polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values. As used herein, approximating language may be applied to modify any quantitative representation that may vary without resulting in a change in the basic function to which it is related. Accordingly, a value modified by a term or terms, such as “about,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11”, and “about 1” may mean from 0.9-1.1. Other meanings of “about” may be apparent from the context, such as rounding off, so, for example “about 1” may also mean from 0.5 to 1.4.

As used herein, a polymer or an oligomer is a macromolecule that consists of monomer units is equal or greater than about one monomer unit. Polymer and oligomer, or polymeric and oligomeric, are used interchangeably here in the invention.

As used herein, the term “alkyl” refers to a monovalent linear, cyclic or branched moiety containing C1 to C24 carbon and only single bonds between carbon atoms in the moiety and including, for example, methyl, ethyl, propyl, isopropyl, n-butyl, sec-butyl, isobutyl, tert-butyl, n-pentyl, n-hexyl, heptyl, 2,4,4-trimethylpentyl, 2-ethylhexyl, n-octyl, n-nonyl, n-decyl, n-undecyl, n-dodecyl, n-hexadecyl, and n-octadecyl.

As used herein, the term “aryl” refers to a monovalent unsaturated aromatic carbocyclic group of from 6 to 24 carbon atoms having a single ring (e.g., phenyl) or multiple condensed (fused) rings, wherein at least one ring is aromatic (e.g., naphthyl, dihydrophenanthrenyl, fluorenyl, or anthryl). Preferred examples include phenyl, methyl phenyl, ethyl phenyl, methyl naphthyl, ethyl naphthyl, and the like.

As used herein, the term “alkoxy” refers to the group —O—R, wherein R is alkyl as defined above.

As used herein, the above groups may be further substituted or unsubstituted. When substituted, hydrogen atoms on the groups are replaced by substituent group(s) that is one or more groups independently selected from alkyl, alkenyl, alkynyl, cycloalkyl, cycloalkenyl, cycloalkynyl, aryl, heteroaryl, heteroalicyclyl, aralkyl, heteroaralkyl, (heteroalicyclyl)alkyl, hydroxy, protected hydroxyl, alkoxy, aryloxy, acyl, ester, mercapto, alkylthio, arylthio, cyano, halogen, carbonyl, thiocarbonyl, O-carbamyl, N-carbamyl, O-thiocarbamyl, N-thiocarbamyl, C-amido, N-amido, S-sulfonamido, N-sulfonamido, C-carboxy, protected C-carboxy, O-carboxy, isocyanato, thiocyanato, isothiocyanato, nitro, silyl, sulfenyl, sulfinyl, sulfonyl, haloalkyl, haloalkoxy, trihalomethanesulfonyl, trihalomethanesulfonamido, and amino, including mono- and di-substituted amino groups, and the protected derivatives thereof. In case that an aryl is substituted, substituents on an aryl group may form a non-aromatic ring fused to the aryl group, including a cycloalkyl, cycloalkenyl, cycloalkynyl, and heterocyclyl.

The term, “polyacrylates” herein refers to acrylic polymers, acrylates, or acrylics, acrylic resins. They are used interchangeably here in the invention.

The term, “moisture cure” herein refers to hardening or vulcanization of the curable portion of the material or polymer by condensation crosslinking reaction of terminal functional group of polymer chains, brought about by water or moisture in the air, in the presence of a moisture curing catalyst.

The invention provides the art with polyacrylate polymer comprising pedant alkoxy or other moisture reactive silyl-functional groups bound to the polymer chain. This polyacrylate polymer, when combined with other components, such as moisture and acid scavengers, moisture cure catalyst, fillers and adhesion promoters, provides a moisture curable composition. The choice and relative amount of the specific moisture reactive silyl functional acrylic and vinyl monomers making up the said polyacrylate compositions used in the moisture curable compositions of this invention depend upon the desired final properties and contemplated end uses of the sealants. The adjustable concentration of the pedant moisture curable functional groups on the polymer backbone will make the cure speed of the sealants faster if necessary. The acrylic and vinyl monomers and their relative amounts in the polyacrylate polymer compositions to achieve the desired properties is within the expertise of those skilled in the art. The invention provides the art with a novel class of polyacrylate compositions with storage stable pedant group moisture curable silyl groups and that can undergo moisture cure. In particular, the polymers demonstrate oil resistance at 150° C. for over 500 hours, and 1000 hours.

In one embodiment of the invention, the polyacrylate polymer with pedant moisture curable functional groups is prepared by polymerizing:
i. 20 to 70% by weight of a first acrylic or methacrylic acid derivative having a structure of CH₂═CR¹COOR², where R¹ is H or CH₃ and R² is a C4-24 linear, branched or cyclic alkyl chain, or combination thereof,
ii. 20 to 70% by weight of a second acrylic or methacrylic acid derivative having a structure of CH₂═CR¹COXR³, where R¹ is H or CH₃; X is O, NR³, S; R³is H, C1-2 alkyl chain or a combination thereof, and
iii. 0.1 to 10% by weight of a silane functional acrylic or methacrylic acid derivative having a structure of CH₂═CR¹COOR⁴SiR⁵₄₋ₙYₙ, where R¹ is H or CH₃; R⁴ is a C1-24 linear, branched or cyclic alkylene or arylene chain; R⁵ is a C1-24 linear, branched or cyclic alkyl chain; Y is C1-3 alkoxy, aryloxy, acetoxy, oximino, enoxy, amino, ester, amide, lactate ester, lactate amide, H, OH, halogen, or combination thereof; n=1, 2, or 3.

Yet another aspect of the invention is directed to a method of forming the moisture curable polyacrylate polymer comprising:
1) polymerizing with a reaction temperature of about 50 to about 120° C. for about 4 to 24 hours of:

a. 40 to 90% by weight of a mixture of:
i. 20 to 70% by weight of a first acrylic or methacrylic acid derivative having a structure of CH₂═CR¹COOR², where R¹ is H or CH₃ and R² is a C4-24 linear, branched or cyclic alkyl chain, or combination thereof,
ii. 20 to 70% by weight of a second acrylic or methacrylic acid derivative having a structure of CH₂═CR¹COXR³, where R¹ is H or CH₃; X is O, NR³, S; R³ is H, C1-2 alkyl chain or a combination thereof, and
iii. 0.1 to 10% by weight of a silane functional acrylic or methacrylic acid derivative having a structure of CH₂═CR¹COOR⁴SiR⁵₄₋ₙYₙ, where R¹ is H or CH₃; R⁴ is a C1-24 linear, branched or cyclic alkylene or arylene chain; R⁵ is a C1-24 linear, branched or cyclic alkyl chain; Y is C1-3 alkoxy, aryloxy, acetoxy, oximino, enoxy, amino, ester, amide, lactate ester, lactate amide, H, OH, halogen, or combination thereof; n=1, 2, or 3,

e. 10-60% by weight of an alcohol of the formula HOR⁶, where R⁶ is C₁₋₄ linear or branched alkyl chain,

f. 0-60% by weight of an ester of the formula R⁷COOR⁸, where R⁷ and R⁸ is independently C₁₋₄ alkyl chain,

g. 0.01 to 5% of an azo or peroxide radical initiator,
2) removing the solvents and any volatile at the temperature from about 50 to about 120° C. under a vacuum from about 10 to 30 psi, and
   wherein the resultant polyacrylate polymer has a weight average molecular weight (Mw) of about 1,000 g/mol to about 100,000 g/mol and a PDI from about 1.5 to 10.

The monomers of components (i), (ii) and (iii) of above are converted by polymerization into the polyacrylates. For polymerization the monomers are chosen such that the resulting polymer can be used as polyacrylates, especially such that the resulting polymer possesses oil resistance properties in accordance with the “Handbook of Specialty Elastomers” edit by Robert C. Klingender and “Specialty and High Performance Rubber: Materials in Use and Their marketplace” by Peter W. Dufton. For these applications the static glass transition temperature of the resulting polymer will advantageously be below about −25° C. to about −30° C.

Examples of the first acrylic or methacrylic acid derivative having a structure of CH₂═CR¹COOR² include n-butyl acrylate, n-butyl methacrylate, n-pentyl acrylate, n-hexyl acrylate, n-heptyl acrylate, and n-octyl acrylate, n-nonyl acrylate, lauryl methacrylate, cyclohexyl acrylate, and branched (meth)acrylic isomers, such as i-butyl acrylate, i-butyl methacrylate, t-butyl methacrylate, 2-ethylhexyl acrylate, stearyl methacrylate, isooctyl acrylate, or combination thereof.

Examples of the second acrylic or methacrylic acid derivative having a structure CH₂═CR¹COOXR³ include methyl acrylate, ethyl acrylate, methoxyethyl acrylate, ethyl methacrylate, methyl methacrylate, or combination thereof.

Examples of the silane functional acrylic or methacrylic acid derivative having a formula CH₂═CR¹COOR⁴SiR⁵₄₋ₙYₙ include trimethoxysilylpropyl(meth)acrylate, Y triethoxysilylpropyl(meth)acrylate, trimethoxysilylethyl(meth)acrylate, methyldimethoxysilylpropyl(meth)acrylate, (meth)acryloxypropylSi(OCHCH₃CON(CH₃)₂)₃, (meth)acryloxypropylSi(OCHCH₃COOCH₂CH₃), or combination thereof.

The polyacrylate polymers may be prepared by solution, emulsion, or bulk polymerization procedures using well-known polymerization techniques, such as free radical, anionic, and cationic techniques. The polymers can then be formed into a neat polymer after the removal of the solvent, coagulation of the latex or melt-processing.

The polymerization is prepared in the presence of one or more organic solvents. Suitable organic solvents or mixtures of solvents are alkanes, such as hexane, heptane, octane, and isooctane; aromatic hydrocarbons, such as benzene, toluene, and xylene; esters, such as ethyl, propyl, butyl and heptyl acetate; halogenated hydrocarbons, such as chlorobenzene; alcohols, such as methanol, ethanol, isopropanol, ethylene glycol, and ethylene glycol; ethers, such as THF, diethyl ether and dibutyl ether; or mixtures thereof.

In one advantageous embodiment of the process, the polymerization reactions proceed in isopropanol using AIBN as a radical initiator. In other variant, the polymerization reactions are conducted with a mixture of isopropanol and ethyl acetate. The acrylic polymers prepared will generally have a weight average molecular weight (Mw) of from 1,000 to 2,000,000 g/mol, more preferably between 1,000 and 100,000 g/mol. The Mw is determined by gel permeation chromatography (GPC) or matrix-assisted laser desorption/ionization mass spectrometry (MALDI-MS).

Another aspect of the invention is directed to a moisture curable composition comprising:
1) about 10 to 90% by weight of a moisture curable polyacrylate polymer prepared from:

i. 20 to 70% by weight of a first acrylic or methacrylic acid derivative having a structure of CH₂═CR¹COOR², where R¹ is H or CH₃ and R² is a C4-24 linear, branched or cyclic alkyl chain, or combination thereof,

ii. 20 to 70% by weight of a second acrylic or methacrylic acid derivative having a structure of CH₂═CR¹COXR³, where R¹ is H or CH₃; X is O, NR³, S; R³ is H, C1-2 alkyl chain or a combination thereof, and

iii. 0.1 to 10% by weight of a silane functional acrylic or methacrylic acid derivative having a structure of CH₂═CR¹COOR⁴SiR⁵₄₋ₙYₙ, where R¹ is H or CH₃; R⁴ is a C1-24 linear, branched or cyclic alkylene or arylene chain; R⁵ is a C1-24 linear, branched or cyclic alkyl chain; Y is C1-3 alkoxy, aryloxy, acetoxy, oximino, enoxy, amino, ester, amide, lactate ester, lactate amide, H, OH, halogen, or combination thereof; n=1, 2, or 3;
2) about 5 to about 90% of a finely divided inorganic filler or a mixer of fillers;
3) about 0.001 to about 0.5% by weight of a moisture or acid scavenger, or combination thereof;
4) about 0.001 to about 5% by weight of a moisture curing catalyst; and
5) optionally, up to about 10% by weight of a crosslinker, adhesion promotor, plasticizer, acid scavenger, pigment, inhibitor, and/or odor mask.

Upon removing the solvent to a content of less than 1% by weight, preferably less than 0.1% by weight, from the moisture curable polyacrylate polymer, fillers and moisture curing catalyst are then added. This process takes place preferably in a batch reactor, or planetary mixer, concentration extruder, such as vent extruder, ring extruder, single-screw extruder, or twin-screw extruder, which are all known to the skilled worker.

The fillers useful in the present invention are finely divided inorganic fillers. By “finely divided” it is meant that the average particle size of the filler is less than about 5 microns. Advantageously, the inorganic fillers have an average particle diameter from about 0.2 to about 2.0 microns. In a particularly advantageous embodiment: i) at least about 90% of the inorganic fillers have a diameter less than 2 microns; and ii) at least about 65% of the inorganic fillers have a diameter less than 1 micron. The fillers may be present in an amount of at least about 15% by weight of the total composition. Desirably, the fillers are present in an amount from about 25% to about 80%, and more desirably from about from about 25% to about 60%, by weight of the total composition.

The moisture curable polyacrylate compositions of the present invention include certain fillers to assist in conferring oil resistance properties to the final cured compositions. The fillers are basic in nature so that they are available to react with any acidic by-products formed in the working environment in which the inventive compositions are intended to be used. By so doing, the fillers neutralize acidic by-products before such by-products degrade the elastomers, thereby improving adhesion retention. These fillers include, for example, lithopone, zirconium silicate, diatomaceous earth, calcium clay, hydroxides, such as hydroxides of calcium, aluminum, magnesium, iron and the like, carbonates, such as carbonates of sodium, potassium, calcium, and magnesium carbonates, metal oxides, such as metal oxides of zinc, magnesium, chromic, zirconium, aluminum, titanium and ferric oxide; and mixtures thereof. The fillers may be present in the composition in any suitable concentration in the curable compositions.

A preferred filler is calcium carbonate. A commercially available example of a calcium carbonate filler suitable for use in the present invention is sold by Omya, Inc. under the tradename OMYACARB® UF-FL. Any commercially available precipitated calcium carbonate can be used with the present invention. The precipitated calcium carbonate should be present, for example, in an amount from about 5 to about 50% by weight of the total composition. Desirably, the calcium carbonate is present in an amount from about 5 to about 15% by weight.

Together with the precipitated calcium carbonate, the present compositions may also include in basic filler component, e.g., magnesium oxide particles. Desirably, the magnesium oxide is present in an amount between about 5 to about 50% by weight of the total composition, such as, for example, from about 10 to about 25% by weight. Any magnesium oxide meeting the above-described physical characteristics may be used in accordance with the present invention. Desirably, the magnesium oxide of the present invention is MAGCHEM 50M and MAGCHEM 200-AD, commercially available from Martin Marietta Magnesia Specialties, Inc., Baltimore, Md. These commercially available fillers contain about 90% by weight or more magnesium oxide particles with a variety of other oxides including, for example, calcium oxide, silicon dioxide, iron oxide, aluminum oxide and sulfur trioxide.

Another type of desirable fillers is reinforcing silica. The silica may be a fumed silica, which may be untreated or treated with an adjuvant so as to render it hydrophobic. The fumed silica should be present at a level of at least about 5% by weight of the composition in order to obtain any substantial reinforcing effect. Although optimal silica level varies depending on the characteristics of the particular silica, it has generally been observed that the thixotropic effect of the silica produces compositions of impractically high viscosity before maximum reinforcing effect is reached. Hydrophobic silica tends to display lower thixotropic effect, and therefore greater amounts can be included in a composition of desired consistency. In choosing the silica level, therefore, desired reinforcement and practical viscosity must be balanced. A hexamethydisilazane treated fumed silica is particularly desirable (HDK2000 by Wacker-Chemie, Burghausen, Germany). A commercially available example of a fumed silica suitable for use in the present invention is sold by Degussa under the trade name AEROSIL R 8200.

To modify the dispensing properties of the compositions through viscosity adjustment, a thixotropic agent for the fillers may be desirable. The thixotropic agent is used in an amount within the range of about 0.05 to about 25% by weight of the total composition. A common example of such a thixotropic agent includes fumed silicas, and may be untreated or treated so as to alter the chemical nature of their surface. Virtually any reinforcing fumed silica may be used. Examples of such treated fumed silica include polydimethylsiloxane treated silica and hexamethyldisilazane treated silica. Such treated silicas are commercially available, such as from Cabot Corporation under the tradename CABSIL ND-TS and Evonik AEROSIL, such as AEROSIL R805. Of the untreated silicas, amorphous and hydrous silicas may be used. For instance, commercially available amorphous silicas include AEROSIL 300 with an average particle size of the primary particles of about 7 nm, AEROSIL 200 with an average particle size of the primary particles of about 12 nm, AEROSIL 130 with an average size of the primary particles of about 16 nm; and commercially available hydrous silicas include NIPSIL E150 with an average particle size of 4.5 nm, NIPSIL E200A with and average particle size of 2.0 nm, and NIPSIL E220A with an average particle size of 1.0 nm (manufactured by Japan Silica Kogya Inc.). Other desirable fillers for use as the thixotropic agent include those constructed of or containing aluminum oxide, silicon nitride, aluminum nitride and silica-coated aluminum nitride. Hydroxyl-functional alcohols are also well-suited as the thixotropic agent, such as tris[copoly(oxypropylene) (oxypropylene)] ether of trimethylol propane, and polyalkylene gycol available commercially from BASF under the tradename PLURACOL V-10.

Other conventional fillers can also be incorporated into the present compositions provided they impart basicity to the compositions, and do not adversely affect the oil resistant curing mechanism and adhesive properties of the final produced therefrom. Generally, any suitable mineral, carbonaceous, glass, or ceramic filler maybe used, including, but not limited to: precipitated silica; clay; metal salts of sulfates; chalk, lime powder; precipitated and/or pyrogenic silicic acid; phosphates; carbon black; quartz; zirconium silicate; gypsum; silicium nitride; boron nitride; zeolite; glass; plastic powder; graphite; synthetic fibers and mixtures thereof. The filler may be used in an amount within the range of about 5 to about 70% by weight of the total composition. A commercially available example of a precipitated silica filler suitable for use in the present is sold by the J.M. Huber under the trade name ZEOTHIX 95.

Organic fillers can also be used, particularly acrylic resins, wood fibers, wood flour, sawdust, cellulose, cotton, pulp, cotton, wood chips, chopped straw, and chaff. Further, short fibers such as glass fibers, glass filament, polyacrylonitrile, carbon fibers, Kevlar fibers, or polyethylene fibers as well can also be added.

To increase the shelf life stability of the moisture curable polyacrylate compositions, moisture scavengers may be added to remove any moisture from the ambient or raw materials. Examples of the moisture scavenger include vinyltrimethoxysilane, vinylmethyldimethoxysilane, hexamethyldisilazane, methyltriethoxysilane, 3-vinylpropyltriethoxysilane, oxime silanes such as methyl-O,O′,O″-butan-2-onetrioximosilane or O,O′,O″,O′″-butan-2-one-tetraoximosilane or benzamidosilanes such as bis(N-methylbenzamido)methylethoxysilane or carbamatosilanes such as carbamatomethyltrimethoxysilane; or combination thereof. The use of methyl, ethyl or vinyl trimethoxysilane, tetramethyl- or tetraethyl-ethoxysilane is also possible. Vinyltrimethoxysilane and tetraethoxysilane are particularly preferred in terms of cost and efficiency. The compositions generally contain up to about 6% by weight.

The moisture curing catalyst which initiates the moisture curing of the compositions in the presence of moisture. The crosslinking reaction is a condensation reaction and leads to a product of crosslinked network through Si—O—Si covenant bond among the moisture reactive components. The catalyst can be metal and non-metal catalysts. Examples of metal catalysts useful in the present invention include tin, titanium, zinc, zirconium, lead, iron cobalt, antimony, manganese and bismuth organometallic compounds. Examples of non-metal based catalysts include amines, amidines, and tetramethylguanidines.

In one embodiment, the moisture curing catalyst useful for facilitating the moisture curing of the polyacrylate compositions is selected from, but is not limited to, dibutyltin dilaurate, dimethyldineodecanoatetin, dioctyltin didecylmercaptide, bis(neodecanoyloxy)dioctylstannane, dimethylbis(oleoyloxy)stannane, dibutyltindiacetate, dibutyltindimethoxide, tinoctoate, isobutyltintriceroate, dibutyltinoxide, solubilized dibutyl tin oxide, dibutyltin bisdiisooctylphthalate, bis-tripropoxysilyl dioctyltin, dibutyltin bis-acetylacetone, silylated dibutyltin dioxide, carbomethoxyphenyl tin tris-uberate, isobutyltin triceroate, dimethyltin dibutyrate, dimethyltin di-neodecanoate, triethyltin tartarate, dibutyltin dibenzoate, tin oleate, tin naphthenate, butyltintri-2-ethylhexylhexoate, tinbutyrate, d-ioctyltin d-idecylm ercaptide, bis(neodecanoyloxy)d-ioctylstannane, or dimethylbis(oleoyloxy)stannane. In one preferred embodiment, the moisture curing catalyst is selected from a group of dimethyldineodecanoatetin (available from Momentive Performance Materials Inc. under the trade name of FOMREZ UL-28, dioctyltin didecylmercaptide (available from Momentive Performance Materials Inc. under the trade name of FOMREZ UL-32), bis(neodecanoyloxy)dioctylstannane (available from Momentive Performance Materials Inc. under the trade name of FOMREZ UL-38), dimethylbis(oleoyloxy)stannane (available from Momentive Performance Materials Inc. under the trade name of FOMREZ UL-50), and combination thereof. More preferably, the moisture curing catalyst is dimethyldineodecanoatetin. In the moisture compositions according to the present invention, the moisture curing catalyst is present in an amount from 0.1 to 5% by weight, based on the total weight of the compositions.

Environmental regulatory agencies and directives, however, have increased or are expected to increase restrictions on the use of organotin compounds in formulated products. For example, compositions with greater than 0.5 wt. % dibutyltin presently require labeling as toxic with reproductive IB classification. Dibutyltin containing compositions are proposed to be completely phased out in consumer applications during the next three to five years. The use of alternative organotin compounds such as dioctyltin compounds and dimethyltin compounds can only be considered as a short-term remedial plan, as these organotin compounds may also be regulated in the future. It would be beneficial to identify non-tin-based compounds that accelerate the condensation curing of moisture-curable polyacrylate compositions. Examples of non-toxic substitutes for organotin catalysts include titanium isopropoxide, zirconium octanoate, iron octanoate, zinc octanoate, cobalt naphthenate, tetrapropyltitanate, tetrabutyltitanate, titanium di-n-butoxide bis(2,4-pentanedionate), titanium diisopropoxide bis(2,4-pentanedionate) and the like. Other non-toxic substitutes for organotin catalysts are based on amino acid compounds. Examples of amino acid catalysts where the amino acid compound is an N-substituted amino acid comprising at least one group other than hydrogen attached to the N-terminus. In another embodiment, the present invention may include curable compositions employing an amino acid compound as a condensation accelerator where the amino acid compound is an O-substituted amino acid comprising a group other than hydrogen attached to the O-terminus. Other suitable amine catalysts include, for example, amino-functional silanes. The non-toxic moisture cure catalyst is employed in an amount sufficient to effectuate moisture-cure, which generally is from about 0.05% to about 5.00% by weight, and advantageously from about 0.5% to about 2.5% by weight.

The present moisture curable compositions may also include one or more crosslinkers. The crosslinkers may be a hexafunctional silane, though other crosslinkers may also be used. Examples of such crosslinkers include, for example, methyltrimethoxysilane, vinyltrimethoxysilane, methyltriethoxysilane, vi nyltriethoxysilane, methyltriacetoxysilane, vinyltriacetoxysilane, methyl tris(N-methylbenzamido)silane, methyl tris-(isopropenoxy)silane, methyl tris-(cyclohexylamino)silane, methyl tris(methyl ethyl ketoximino)silane, vinyl tris-(methyl ethyl ketoximino)silane, methyl tris-(methyl isobutyl ketoximino)silane, vinyl tris-(methyl isobutyl ketoximino)silane, tetrakis-(methyl ethyl ketoximino)silane, tetrakis-(methylisobutyl ketoximino)silane, tetrakis-(methyl amyl ketoximino)silane, dimethyl bis-(methyl ethylketoximino)silane, methyl vinyl bis-(methyl ethyl ketoximino)silane,methyl vinyl bis-(methyl isobutyl ketoximino)silane, methylvinyl bis-(methyl amyl ketoximino)silane, tetrafunctionalalkoxy-ketoxime silane, tetrafunctional alkoxy-ketoximinosilane, tris- or tetrakis-enoxysilane, tris- or tetrakis-lactate amidosilane and tris- or tetrakis-lactate estersilane.

Typically, the crosslinkers used in of the present compositions are present from about 1 to about 10% by weight of the total composition. The exact concentration of the crosslinker; however, may vary according to the specific reagents, the desired cure rate, molecular weight of the moisture curable polyacrylate compositions used in the compositions.

The preparation of the moisture curable polyacrylate compositions can take place by mixing the polyacrylate polymer and compositions in the invention, fillers and optionally the other ingredients. This mixing process can take place in suitable dispersing units, e.g., a high-speed mixer, planetary mixer and Brabender mixer. In all cases, care is taken that the mixture does not come into contact with moisture, which could lead to an undesirable curing. Suitable measures are sufficiently known in the art: mixing under vacuum or in an inert atmosphere under a protective gas and drying/heating individual components before addition.

The moisture curable compositions can further comprise, optionally, silane adhesion promotors, functional polymeric and/or oligomeric adhesion promoters. An adhesion promoter may act to enhance the adhesive character of the curable polyacrylate composition for a specific substrate (i.e., metal, glass, plastics, ceramic, and blends thereof). Any suitable adhesion promoter may be employed for such purpose, depending on the specific substrate elements employed in a given application. Examples of silane adhesion promoters that are useful include, but are not limited to, C3-C24 alkyl trialkoxysilane, (meth)acryloxypropyl trialkoxysilane, chloropropylmethoxysilane, vinyltrimethoxysilane, vinyltriethoxysilane, vinyltrismethoxyethoxysilane, vinylbenzylpropylthmethoxysilane, aminopropyltrimethoxysilane, vinylthacetoxysilane, glycidoxypropyltrialkoxysilane, beta.-(3,4-epoxycyclohexyl)ethyltrimethoxysilane, mercaptopropylmethoxysilane, 3-aminopropyltriethoxysilane, aminomethyltrimethoxysilane, aminomethyltriethoxysilane, 3-aminopropylmethyldiethoxysilane, (N-2-aminoethyl)-3-aminopropyltrimethoxysilane, (N-2-aminoethyl)-3-aminopropyltriethoxysilane, diethylenetriaminopropyltrimethoxysilane, phenylaminomethyltrimethoxysilane, (N-2-aminoethyl)-3-aminopropylmethyldimethoxysilane, 3-(N-phenylamino)propyltrimethoxysilane, 3-piperazinylpropylmethyldimethoxysilane, 3-(N,N-dimethylaminopropyl)aminopropylmethyldimethoxysilane, tri[(3-triethoxysilyl)propyl]amine, tri[(3-trimethoxysilyl)propyl]amine, 3-(N,N-dimethylamino)propyltrimethoxysilane, 3-(N,N-dimethylamino)-propyltriethoxysilane, (N,N-dimethylamino)methyltrimethoxysilane, (N,N-dimethylamino)methyltriethoxysilane, bis(3-trimethoxysilyl)propylamine, bis(3-triethoxysilyl)propylamin, and mixtures thereof, particularly preferably of 3-aminopropyltrimethoxysilane, 3-aminopropyltriethoxysilane, aminomethyltrimethoxysilane, aminomethyltriethoxysilane, 3-(N,N-dimethylamino)propyltrimethoxysilane, 3-(N,N-dimethylamino)propyltriethoxysilane, (N,N-dimethylamino)methyltrimethoxysilane, (N,N-dimethylamino)methyltriethoxysilane, bis(3-trimethoxysilyl)propylamine, bis(3-triethoxysilyl)propylamine, and mixtures thereof.

The adhesion promoter will typically be used in amounts of from 0.2 to 40 weight percent, more preferably, 1 to 20 weight percent of the whole curable polyacrylate compositions.

In the present compositions, effective amount of plasticizers may be added to ensure the desired workability of uncured compositions and performance of the final cured compositions. Suitable plasticizers include, for example, trimethyl-terminated polyorganosiloxanes, petroleum derived organic oils, polybutenes, alkyl phosphates, polyalkylene glycol, poly(propylene oxides), hydroxyethylated alkyl phenol, dialkyldithiophosphonate, poly(isobutylenes), poly(a-olefins) and mixtures thereof. The plasticizer component may provide further oil resistance to the cured elastomer. Accordingly, from about 1 to about 50%, preferably from about 10 to about 35% by weight of a selected plasticizer can be incorporated into the compositions of the present invention.

To increase the shelf life stability of the moisture curable polyacrylate compositions, acid scavengers may be added to remove any acid impurities, e.g., acrylic acid, from the acrylic monomers. Examples of the acid scavenger include hexamethyldisilazane, ethylene oxide, sodium bicarbonate, sodium carbonate, calcium carbonate, magnesium oxide, or combination thereof.

The present moisture curable compositions may also contain other additives so long as they do not inhibit the curing mechanism or their intended uses. For example, conventional additives such as pigments, inhibitors, odor masks, and the like, may be included.

Reaction products of the present moisture curable compositions are useful as adhesives or sealants for bonding, sealing, encapsulating metal surfaces that are exposed to oil during their intended use. The moisture curable polyacrylate compositions of the present invention may also be formed into many different configurations and then addition cured. Articles formed in such a manner are useful in various industries where there is a need for oil resistant polyacrylate based elastomeric articles. In vehicular assembly industry, for example, O-rings, hoses, seals, and gaskets can be formed from the present compositions. Other conventional uses requiring good sealing properties, as well as oil resistance are also contemplated for the moisture-curable compositions.

Yet another aspect of the invention is directed to the method of using the moisture curable polyacrylate compositions to make polyacrylate adhesives and sealants. The polyacrylate adhesive or sealant compositions comprise the polyacrylate polymers in the invention and fillers.

In one aspect of the present invention, there is provided a method of applying the curable moisture curable polyacrylate compositions to a surface exposed to oil during its intended use. The surface to which the present compositions are applied to can be any surface that is exposed to oil, such as work surfaces of conventional internal combustion engines. This method includes applying the composition of the present invention to a work surface. The work surface may be constructed of a variety of materials, such as most metals, glass, and commodity or engineered plastics. In yet another aspect of the present invention, there is provided a method of using an oil resistant mechanical seal, which remains sealed after exposure to oil. This method includes applying a seal forming amount of the composition as described previously onto a surface of a mechanical part. A seal is then formed between at least two mechanical surfaces by addition-cure through exposure to elevated temperature conditions, e.g., 150° C., after which the seal remains competent even when exposed to oil at extreme temperature conditions over extended periods of time, e.g., greater than 500 hours, or even greater than 1000 hours.

In yet another aspect of the present invention, there is provided a method of using an oil resistant sealing member that remains adhesive after contact with and/or immersion in oil. This method includes forming a seal between two or more surfaces by applying therebetween the oil resistant sealing member formed from a composition according to the present invention. With respect to the second embodiment of the present invention, there is provided a method of improving oil resistance in such a polyacrylate sealant composition. This method includes the steps of (a) providing the polyacrylate sealant, (b) incorporating into the sealant at least about 5% by weight of a composition that includes magnesium oxide particles having a mean particle size of about 0.5 uM to about 1.5 tM and a mean surface area of about 50 M2/g to about 175 M2/g and (c) crosslinking the polyacrylate sealant to form an oil resistant elastomeric article. Desirably, this sealant composition includes from about 10 to about 90% by weight of a polyacrylate polymer, from about 1 to about 20% by weight of fumed silica, from about 5 to about 50% by weight of a precipitated calcium carbonate and/or magnesium oxide, from about 1 to about 10% by weight of a crosslinker and from about 0.05 to about 5% by weight of a moisture cure catalyst, each of which is by weight of the total composition. The sealant composition can also include other optional components including for example, plasticizers, adhesion promoters, pigments and the like.

### EXAMPLES

The following examples are provided for illustrative purposes only, without wishing to subject them to any unnecessary restriction.

Butyl acrylate (BA), ethyl acrylate (EA), 2,2′-azobis-(2-methyl propionitrile (AlBN), isopropanol (IPA), ethyl acetate, and dibutyltin dilaurate (DBDTL) are available from Sigma-Aldrich.

t-Amyl peroxypivalate (t-APP, 75%, 0.5 g) is available from Akzo Nobel.

Methacryloxypropyl trimethoxysilanee (MATMS), and vi nyltrimethoxysilane are available from Gelest Inc.

SF105F engine oil is available from Test Monitoring Center.

All fillers and additives are commercially available from various suppliers

Skin-over Time Measurement was measured according to ASTM 725: The skin-over time was determined under standard climatic conditions (25+/−2° C., relative humidity 50+/−5%). The samples were applied to a sheet of paper and drawn out to a skin with a putty knife (thickness of about 2 mm, width of about 7 cm). A stopwatch was started immediately. The surface was touched lightly with the fingertip until the composition no longer adheres to the fingertip. The skin-over time was recorded in hours.

The elongation at break, and tensile stress values (E modulus) were determined in accordance with ASTM 708 using the tensile test. Sample dumbbell specimens with the following dimensions were used as the test pieces: thickness: 2+/−0.2 mm; gauge width: 10+/−0.5 mm; gauge length: about 45 mm; total length: 9 cm. The test took place after seven days of curing. A two mm-thick film was drawn out of the material. The film was stored for seven days under standard climatic conditions, and the dumbbells were then punched out. Three dumbbells were made for each test. The test was carried out under standard climatic conditions. The specimens were acclimatized to the test temperature (i.e., stored) for at least 20 minutes before the measurement. Before the measurement, the thickness of the test specimens was measured at three places at room temperature using a vernier caliper; i.e., for the dumbbells, at the ends, and the middle within the initial gauge length. The average values were entered in the measuring program. The test specimens were clamped in the tensile testing machine so that the longitudinal axis coincided with the mechanical axis of the tensile testing machine and the largest possible surface of the grips was grasped, without the narrow section being clamped. At a test speed of 50 mm/min, the dumbbell tensioned to a preload of <0.1 MPa.

A Rheometrics Dynamic Mechanical Analyzer (Model RDA 700) was used to obtain the elastic moduli (G′), loss modulus (G″) and tan delta versus temperature sweep. The instrument was controlled by Rhios software version 4.3.2. Parallel plates 8 mm in diameter and separated by a gap of about 2 mm were used. The sample was loaded and then cooled to about −100° C. and the time program started. The program test increased the temperature at 5° C. intervals followed by a soak time at each temperature of 10 seconds. The convection oven was flushed continuously with nitrogen. The frequency was maintained at 10 rad/s. The initial strain at the start of the test was 0.05% (at the outer edge of the plates). An autostrain option in the software was used to maintain an accurately measurable torque throughout the test. The option was configured such that the maximum applied strain allowed by the software was 80%. The autostrain program adjusted the strain at each temperature increment if warranted using the following procedure. If the torque was below 200 g-cm the strain was increased by 25% of the current value. If the torque was above 1200 g-cm it was decreased by 25% of the current value. At torques between 200 and 1200 g-cm no change in strain was made at that temperature increment. The shear storage or elastic modulus (G′) and the shear loss modulus (G″) are calculated by the software from the torque and strain data. Their ratio, G″/G′, also known as the tan delta, was also calculated. The soft block Tg was taken as the maximum in tan delta. Flow temperature was reported as the temperature where elastic modulus and loss modulus values equal to one another: G″=G′.

### EXAMPLES 1-8

### Preparation of Moisture Curable Polyacrylate Compositions

Acrylic polymers (Example 1 through 8) were prepared by the same procedure, and their monomer components and polymer properties are listed in Table 1.

Example 7 was prepared as follows: A four-neck 500 mL round-bottom reaction flask was equipped with a temperature control device, a condenser, an overhead mechanical stirrer, Two addition funnel and nitrogen inlet/outlet. The set-up was purged with nitrogen gas for 15 min. To one of the addition funnels was charged a monomer mixture of butyl acrylate (165.0 g), ethyl acrylate (132.0 g), methacryloxypropyltrimethoxysilanee (MATMS, 3.0g). To another funnel was charged the initiator solution of 2,2′-azobis-(2-methyl propionitrile) (AIBN, 0.18 g) and isopropanol (IPA, 45 g). To the reaction flask was charged initiator 2,2′-azobis-(2-methyl propionitrile) (AIBN, 0.02 g) and IPA (30 g). The reaction flask was heated to a reflux and held for 15 min. Then, the monomer mixture in the funnel was added continuously over 2 hours at a constant rate. Simultaneously, the initiator solution in the funnel was added continuously over 3 hours at a constant rate. Upon complete addition, the mixture was stirred for an extra 1 hour at reflux. Monomer scavenger solution of t-amyl peroxypivalate (t-APP, 75%, 0.5 g) and IPA (20 g) were charged into the initiator funnel and then added into the reaction mixture over 1 hour and hold for extra 1 hour at reflux. The reaction solvent and any volatiles were stripped off under vacuum at the reflux temperature. The resulting polyacrylate polymer was cool to room temperature under nitrogen. Moisture scavenger vinyltrimethoxysilane (0.1 PPM) was added and mixed for 30min. The final obtained polyacrylate polymer has a weight average molecular weight (M_{w}) of 30500, PDI 2.9, determined by GPC.

TABLE 1
Monomer compositions and polymer properties

| Example | | 1(C) | 2(C) | 3(C) | 4 | 5 | 6 | 7 | 8 |
|---|---|---|---|---|---|---|---|---|---|
| Monomer | BA, g | 150.0 | 105.0 | 150.0 | 165.0 | 165.0 | 165.0 | 165.0 | 165.0 |
| composition | EA, g | 146.4 | 191.4 | 147.3 | 131.1 | 131.4 | 131.7 | 132.0 | 132.3 |
| | MATMS, g | 3.6 | 3.6 | 2.7 | 3.9 | 3.6 | 3.3 | 3.0 | 2.7 |

| | | | | | | | | |
|---|---|---|---|---|---|---|---|---|
| Ethyl acetate, g | 100 | 0 | 20 | 0 | 0 | 0 | 0 | 0 |
| Isopropanol, g | 0 | 100 | 60 | 30 | 30 | 30 | 30 | 30 |
| Mw, g/mol | 47,893 | 20,834 | 40257 | 32186 | 31803 | 30610 | 30510 | 30641 |
| PDI | 3.2 | 2.2 | 3.28 | 2.7 | 3 | 2.8 | 2.9 | 2.8 |
| Viscosity, 60^{°} C., Pa-s | 519 | 189 | 161 | 38.1 | 35.4 | 29.7 | 30.5 | 30.4 |

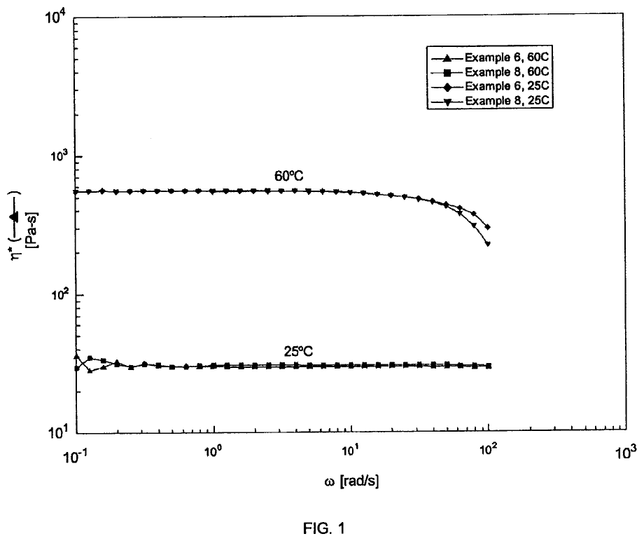

Example 1(C) prepared with 100 g of ethyl acetate as the solvent led to a polymer with high molecular weight and high viscosity. On the other hand, 2(C) using 100 g of isopropanol as the solvent resulted in a polymer with low molecular weight and low viscosity polymer. By mixing the two solvent still generated a polymer with high Mw and viscosity, as in Example 3(C). Reducing the isopropanol content led to an acceptable Mw and viscosity for the application of this invention as showed by examples 4 to 8 in Table 1, and improved the process efficiency with high polymer solid content and easiness of recycling solvent. FIG. 1 shows frequency sweep tests of the polymers at both 25° C. and 60° C., and all the polymers maintain constant viscosity over the frequency range from 10⁻¹ to 10¹ rad/s.

TABLE 2
Polymer properties after moisture cure*

| Example | 1(C) | 2(C) | 3(C) | 4 | 5 | 6 | 7 | 8 |
|---|---|---|---|---|---|---|---|---|
| Skin over | N/A | N/A | <2 h | <5 h | <5 h | <8 h | <8 h | <8 h |
| time**, hr | | | | | | | | |
| RDA Tg, ^{°} C. | −24 | −20 | −24 | −25 | −25 | −25 | −25 | −25 |
| G', 60° C., | N/A | N/A | 16.1 | 18.5 | 14.6 | 12.2 | 10.9 | 6.4 |
| KPa | | | | | | | | |
| G”, 60^{°} C., | N/A | N/A | 2.8 | 3.4 | 3.1 | 4.1 | 2.6 | 3.2 |
| KPa | | | | | | | | |
| Elonga- | N/A | N/A | 539 | 220 | 270 | 330 | 370 | 420 |
| tion***, % | | | | | | | | |

*All samples contained 0.1 g moisture scavenger VTMO and 0.5% wt DBDTL.
**Skin over time was measured according to STM 725;
***Elongation was measured according to STM 708.

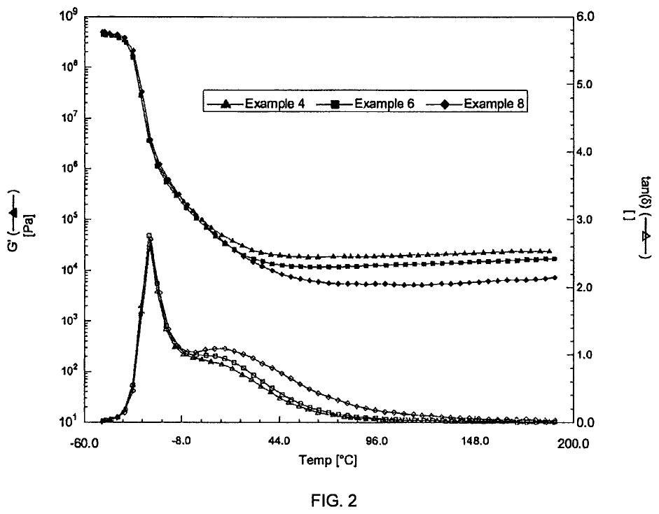

Example 1(C) was an unstable polymer and gelled by itself overtime without DBDTL. Example 2(C), on the other hand, did not cure with the addition of DBDTL. Example 3(C) cured too fast in the presence of DBDTL. Examples 4 to 8 all showed a good and manageable cure rate for the applications of this applications. As showed in Table 2 and FIG. 2, the polymer elastic modulus G′ increased when more moisture reactive monomer MATMS was incorporated in the polymer composition. The glass transition temperature Tg is mainly determined by the ratio of the main monomers of BA and EA. With less of MATMS, the polymer had higher tensile elongation.

### Example 9

77 parts of the example 3(C) polymer with 9 parts precipitated chalk, and 1.3 parts of carbon black were mixed. Then 3 parts of highly treated hydrophobic silica Aerosil 812S were added. After thoroughly mixing under vacuum, 0.5 part of vinyl trimethoxy silane and 0.5 part of amino propyl trimethoxy silane as adhesion promoter were added. A combination of 0.35 part of tetramethyl guanidine and 0.35 part moisture cure tin catalyst (DBDTL) were added under anhydrous conditions. Entire mass was mixed at room temperature and stored in a moisture free environment.

### Example 10

55 parts of the example 6 polymer with 21 parts of ground chalk, 7.5 parts of precipitated chalk, and 1 part of carbon black were mixed. Then 1.5 parts of highly treated hydrophobic silica Aerosil 812S was added. After thoroughly mixing under vacuum, 1 part of vinyl trimethoxy silane and 0.5 part of amino propyl trimethoxy silane as adhesion promoter were added. A combination of 0.25 part tetramethyl guanidine and 0.25 part moisture cure tin catalyst were added under anhydrous conditions. Entire mass was mixed at room temperature and stored in a moisture free environment.

### Example 11

60 parts of the example 8 polymer with 24 parts of ground chalk, 8 parts of precipitated chalk, and1 part of carbon black were mixed. Then 1.5 parts of highly treated hydrophobic silica Aerosil 812S was added. After thoroughly mixing under vacuum, 1.2 parts of vinyl trimethoxy silane and 0.6 part of amino propyl trimethoxy silane as adhesion promoter were added. A combination of 0.25 part titanium acetyl acetonate and 0.25 part titanium alkoxy moisture cure catalyst were added under anhydrous conditions. Entire mass was mixed at room temperature and stored in a moisture free environment.

TABLE 3
Properties of sealant compositions with the polymers

| Properties | Example 9 | Example 10 | Example 11 |
|---|---|---|---|
| Example of the polymer | 3(C) | 6 | 8 |
| Skin over time | 15 min | 45 min | 45 min |
| Al Lap 1 mm gap (Mpa) | 0.7 | 1.1 | 0.51 |
| Failure mode* | 100% CF | 100% CF | 100% CF |
| Failure mode after | 100% CF | 100% CF | 100% CF |
| aged 1 month** | | | |
| Tensile after aged | 0.8 | 1 | 0.6 |
| 1 month**, Mpa | | | |
| Elongation after aged | 265 | 153 | 168 |
| 1 month**, % | | | |

*CF stands for cohesive failure;
**aged in SF-105 engine oil at 150° C.

Examples 9 to 11 were cured in the presence of moisture cure catalyst. After one week of curing at 25° C. and 50% RH in the air, the specimens of fully cured compositions were submerged and aged in SF-105 engine oil at 150° C. for one month. The specimens were then taken out from oil and examined for their degradation including loss of the integrity and shape of specimens or dissolved partially or completely in the engine oil. Only those specimens surviving 1000 hours were further tested for elongation and tensile properties. Example 9 prepared with Example 3(C) polymer cured too fast but provided good elongation with its high Mw and low MAIMS content, resulting in low crosslinking density. Example 10 prepared with Example 6 polymer showed high tensile strength but low elongation because of high MAIMS content and resulted in high crosslinking density. Example 11 had improved elongation with low MAIMS content. Examples 10 and 11 had good cure rates: longer and more workable time before cure. Overall, both examples 10 and 11 had good compromised properties.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A moisture curable polyacrylate polymer prepared from:
i. 20 to 70% by weight of a first acrylic or methacrylic acid derivative having a structure of CH₂═CR¹COOR², where R¹ is H or CH₃ and R² is a C4-24 linear, branched or cyclic alkyl chain, or combination thereof,
ii. 20 to 70% by weight of a second acrylic or methacrylic acid derivative having a structure of CH₂═CR¹COXR³, where R¹ is H or CH₃; X is O, NR³, S; R³ is H, C1-2 alkyl chain or a combination thereof, and
iii. 0.1 to 10% by weight of a silane functional acrylic or methacrylic acid derivative having a structure of CH₂═CR¹COOR⁴SiR⁵₃₋ₙₘYₙ, where R¹ is H or CH₃; R⁴ is a C1-24 linear, branched or cyclic alkylene or arylene chain; R⁵ is a C1-24 linear, branched or cyclic alkyl chain; Y is C1-3 alkoxy, aryloxy, acetoxy, oximino, enoxy, amino, ester, amide, lactate ester, lactate amide, H, OH, halogen, or combination thereof; n=1, 2, or 3.

2. The moisture curable polyacrylate polymer of claim 1, wherein
(i) the first acrylic or methacrylic acid derivative is n-butyl acrylate, n-butyl methacrylate, n-pentyl acrylate, n-hexyl acrylate, n-heptyl acrylate, and n-octyl acrylate, n-nonyl acrylate, lauryl methacrylate, cyclohexyl acrylate, and branched (meth)acrylic isomers, such as i-butyl acrylate, i-butyl methacrylate, t-butyl methacrylate, 2-ethylhexyl acrylate, stearyl methacrylate, isooctyl acrylate; or combination thereof.

3. The moisture curable polyacrylate composition of claim 1, wherein
(ii) the second acrylic or methacrylic acid derivative is methyl acrylate, ethyl acrylate, methoxyethyl acrylate, ethyl methacrylate, methyl methacrylate, or combination thereof.

4. The moisture curable polyacrylate composition of claim 1, wherein
(iii) the silane functional acrylic or methacrylic acid derivative is trimethoxysilylpropyl (meth)acrylate, triethoxysilylpropyl (meth)acrylate, trimethoxysilylethyl (meth)acrylate, methyldimethoxysilylpropyl (meth)acrylate, (meth)acryloxypropylSi(OCHCH₃CON(CH₃)₂)₃, (meth)acryloxypropylSi(OCHCH₃COOCH₂CH₃), or combination thereof.

5. The moisture curable polyacrylate polymer of claim 1, wherein
i. the first acrylic or methacrylic acid derivative n-butyl acrylate and/or 2-ethylhexyl acrylate and
ii. the second acrylic or methacrylic acid derivative methyl acrylate, ethyl acrylate, and/or methoxyethyl acrylate.

6. A moisture curable composition comprising:
1. about 10 to 90% by weight of a moisture curable polyacrylate polymer prepared from:
i. 20 to 70% by weight of a first acrylic or methacrylic acid derivative having a structure of CH₂═CR¹COOR², where R¹ is H or CH₃ and R² is a C4-24 linear, branched or cyclic alkyl chain, or combination thereof,
ii. 20 to 70% by weight of a second acrylic or methacrylic acid derivative having a structure of CH₂═CR¹COXR³, where R¹ is H or CH₃; X is O, NR³, S; R³ is H, C1-2 alkyl chain or a combination thereof, and
iii. 0.1 to 10% by weight of a silane functional acrylic or methacrylic acid derivative having a structure of CH₂═CR¹COOR⁴SiR⁵₃₋ₙYₙ, where R¹ is H or CH₃; R⁴ is a C1-24 linear, branched or cyclic alkylene or arylene chain; R⁵ is a C1-24 linear, branched or cyclic alkyl chain; Y is C1-3 alkoxy, aryloxy, acetoxy, oximino, enoxy, amino, ester, amide, lactate ester, lactate amide, H, OH, halogen, or combination thereof; n=1, 2, or 3;
2) about 5 to about 90% of a finely divided inorganic filler or a mixer of fillers;
3) about 0.001 to about 0.5% by weight of a moisture or acid scavenger, or combination thereof;
4) about 0.001 to about 5% by weight of a moisture curing catalyst; and
5) optionally, up to about 10% by weight of a crosslinker, adhesion promotor, plasticizer, acid scavenger, pigment, inhibitor, and/or odor mask.

7. The moisture curable composition of claim 6, wherein said filler is selected from the group consisting of fumed silica, clay, metal salts of carbonates, sulfates, phosphates, carbon black, metal oxides, quartz, zirconium silicate, gypsum, silicon nitride, boron nitride, zeolite, glass, and combinations thereof.

8. The moisture curable composition of claim 6, wherein said filler is selected from the group consisting of a combination of fumed silica, calcium carbonates and magnesium oxide.

9. The moisture curable composition of claim 6, wherein said filler selected from the group consisting of silicone resins, organic fillers, plastic powder, and combinations thereof.

10. The moisture curable polyacrylate composition of claim 6 wherein the moisture scavenger is vinyltrimethoxysilane, vinylmethyldimethoxysilane, hexamethyldisilazane, methyltriethoxysilane, methyltrimethoxysilane, or combination thereof.

11. The moisture curable polyacrylate composition of claim 6 wherein the acid scavenger is hexamethyldisilazane, ethylene oxide, sodium bicarbonate, sodium carbonate, calcium carbonate, magnesium oxide, or combination thereof.

12. The moisture curable silane modified polyacrylate composition of claim 6 wherein the moisture curing catalyst is an organometallic compound of tin, titanium, zinc, zirconium, lead, iron cobalt, antimony, manganese and bismuth, or amines, amidines, guanidines, or combination thereof.

13. The moisture curable composition of claim 6, wherein the adhesion promotor is a moisture reactive silane.

14. The moisture curable composition of claim 13, wherein said moisture reactive silane is selected from the group consisting of alkoxy silanes, acetoxy silanes, enoxy silanes, oximino silanes, amino silanes, lactate ester silanes, lactate amido silanes and combinations thereof.

15. The moisture curable composition of claim 14, wherein said moisture reactive silane comprises vinyltrioximinosilane, vinyltrialkoxysilane and combinations thereof.

16. The composition of claim 6, wherein said adhesion promoter is selected from the group consisting of tris(3-(trimethoxysilyl) propyl) isocyanurate, γ-ureidopropyltrimethoxy silane, γ-aminopropyltrimethoxy silane, and combinations thereof.

17. A cured composition of the moisture curable composition of claim 6.

18. The cured composition of claim 17 which is an automotive gasket.

19. A method of preparing a moisture curable polyacrylate polymer comprising:
1) polymerizing with a reaction temperature of about 50 to about 120° C. for about 4 to 24 hours of:
a. 40 to 90% by weight of a mixture of:
i. 20 to 70% by weight of a first acrylic or methacrylic acid derivative having a structure of CH₂═CR¹COOR², where R¹ is H or CH₃ and R² is a C4-24 linear, branched or cyclic alkyl chain, or combination thereof,
ii. 20 to 70% by weight of a second acrylic or methacrylic acid derivative having a structure of CH₂═CR¹COXR³, where R¹ is H or CH₃; X is O, NR³, S; R³ is H, C1-2 alkyl chain or a combination thereof, and
iii. 0.1 to 10% by weight of a silane functional acrylic or methacrylic acid derivative having a structure of CH₂═CR¹COOR⁴SiR⁵₃₋ₙYₙ, where R¹ is H or CH₃; R⁴ is a C1-24 linear, branched or cyclic alkylene or arylene chain; R⁵ is a C1-24 linear, branched or cyclic alkyl chain; Y is C1-3 alkoxy, aryloxy, acetoxy, oximino, enoxy, amino, ester, amide, lactate ester, lactate amide, H, OH, halogen, or combination thereof; n=1, 2, or 3,
b. 10-60% by weight of an alcohol of the formula HOR⁶, where R⁶ is C₁₋₄ linear or branched alkyl chain,
c. 0-60% by weight of an ester of the formula R⁷COOR⁸, where R⁷ and R⁸ is independently C₁₋₄ alkyl chain,
d. 0.01 to 5% of an azo or peroxide radical initiator,
2) removing the solvents and any volatile at the temperature from about 50 to about 120° C. under a vacuum from about 10 to 30 psi, and wherein the resultant polyacrylate polymer has a weight average molecular weight (Mw) of about 1,000 g/mol to about 100,000 g/mol and a PDI from about 1.5 to 10.
